(19) United States
(12) Patent Application Publication
(10) Pub. No.: US 2019/0119131 A1
(43) Pub. Date: Apr. 25, 2019

(54) WATER TREATMENT USING CRYPTOCRYSTALLINE MAGNESITE

(71) Applicant: CSIR, Pretoria (ZA)

(72) Inventors: Masindi Vhahangwele, Mukula (ZA); Wilson Mugera Gitari, Louis Trichardt (ZA)

(21) Appl. No.: 15/568,203

(22) PCT Filed: Aug. 17, 2015
(86) PCT No.: PCT/ZA2015/050003

§ 371 Date: Oct. 20, 2017

(30) Foreign Application Priority Data
May 21, 2015 (ZA) 2015/03623

(51) Int. Cl. C02F 1/52; C02F 1/66

(52) U.S. Cl. CPC C02F 1/5236; C02F 2103/10; C02F 1/5263; C02F 1/66

(57) ABSTRACT

A process for the treatment of contaminated water (10) includes contacting the contaminated water with cryptocrystalline magnesite (14) thereby to remove one or more contaminants from the water. The invention extends to powdered cryptocrystalline magnesite with a particle size such that the powdered or particulate cryptocrystalline magnesite is able to pass through a 125 μm particle size sieve for use in the treatment of water.

### FIELD OF THE INVENTION

This invention relates to the treatment of water. In particular, the invention relates to a process for the treatment of contaminated water.

### BACKGROUND OF THE INVENTION

Mining contributes significantly to the Gross Domestic Product of a country. However, it has been proven that in the long term the mining of coal and gold (in particular) poses devastating impacts to the environment and living organisms. Voids left in the ground from mining activities can get filled with rainfall and groundwater. Eventually, the water will react with the surrounding geology and oxygen from the atmosphere producing Acid Mine Drainage (AMD) effluent—water that is acidic and impregnated with metals leached from the surrounding geology. Often, the AMD contain high concentrations of Fe, Mn, Al and SO₄²⁻ in addition to traces of Pb, Co, Ni, Cu, Zn, Mg, Ca and Na. These effluents impact surface and subsurface water resources negatively and have to be treated before release to receiving aquatic systems. Worldwide, a number of treatment methods, both passive and active, have been proposed and are being used for abating AMD.

In South Africa, limestone is the main agent for treatment of AMD. However, the use of limestone is unsuitable for removal of metals because it fails to raise the pH above 7. An attempt has been made to integrate limestone treatment with lime which raises the pH to greater than 12 however the cost of the lime is a limitation. Synthetic magnesium hydroxide has been used for AMD treatment and although effective, its production cost is a limiting factor.

An object of this invention is to provide a material and process for the treatment of water, e.g. contaminated water polluted with industrial waste or metals, or water that is acidic and metalliferous drainage water, such as AMD.

### SUMMARY OF THE INVENTION

This invention relates to a process for the treatment of water, wherein the water is contacted with cryptocrystalline magnesite.

Thus, according to the invention, there is provided a process for the treatment of contaminated water, the process including contacting the contaminated water with cryptocrystalline magnesite thereby to remove one or more contaminants from the water.

Magnesite is a mineral most commonly of white colour. Individual crystals are not visible in polarized light under an optical microscope. Magnesite ores are divided into three varieties, namely, massive, banded and brecciated. Each of the magnesite varieties is located in specific places of the geologic section or is typical for individual deposits. A magnesite body consists of massive and brecciated magnesite ores. Central parts of the magnesite body are represented by massive amorphous magnesite with a high content of MgO up to 87-90%.

Naturally, magnesite is found in two forms, namely, crystalline and cryptocrystalline, which is more amorphous and less crystalline than crystalline magnesite, but which has a microscopic crystalline structure. Different forms of magnesite have different X-ray characteristics. For example, crystalline magnesite usually shows a double sharp peak at 2.74 and 2.70 A, whereas cryptocrystalline magnesite usually has a broader peak at 2.74 A and a weak shoulder at 2.70 A. In contrast, an amorphous material will not show peaks on XRD. Cryptocrystalline magnesites are more heterogeneous than crystalline magnesites and typically include free silica. Other differences between cryptocrystalline and crystalline magnesites are discussed by Nasedkin et al. (Nasedkin V. V, Krupenin M. T., Safonov Yu. G, Boeva N. M, Efremova S. V. and Shevelev A. I. 2001 The comparison of amorphous (cryptocrystalline) and crystalline magnesites. Mineralia Slovaca, 33 (2001), 567-574). This document is incorporated herein by reference.

The contaminated water may be acidic, i.e. the contaminated water may have a pH of less than 7.

The contaminated water may comprise metal or metalloid ions as contaminants. Contacting the contaminated water with cryptocrystalline magnesite may include mixing particulate cryptocrystalline magnesite with the contaminated water thereby to remove at least some of the metal or metalloid ion contaminants from the water.

In one embodiment of the invention, the method includes separating treated water from the cryptocrystalline magnesite, e.g. using filtration.

Contacting the contaminated water with cryptocrystalline thereby to remove one or more contaminants from the water may instead include passing the contaminated water through a bed of the cryptocrystalline magnesite.

The contaminated water may comprise oxyanions, e.g. sulphate, of one or more elements selected from the group consisting of arsenic, chromium, boron, selenium and molybdenum. Said oxyanions may be removed from the contaminated water by contact with the cryptocrystalline magnesite.

Contacting the contaminated water with cryptocrystalline magnesite may includes using sufficient cryptocrystalline magnesite to raise the pH of the water to >10, preferably to between 10 and 12, more preferably to between 10 and 11.

The metal ions removed from the water as contaminants may be selected from the group consisting of Al, Mn, Ca, Mg and Fe ions. These metal ions may precipitate as for example hydroxides, oxyhydrosulphates or hydrosulphates. The process of the invention is thus able to neutralize and attenuate inorganic contaminants such as Al, Mn and Fe, which may precipitate as hydroxides, oxyhydrosulphates and hydrosulphates.

In one embodiment of the invention, the metal ions removed from the contaminated water as contaminants are divalent ions selected from the group consisting of Co(II), Cu(II), Ni(II), Pb(II) and Zn(II). The process of the invention may thus lead to the precipitation and recovery of divalent metal ions, in particular species of Co(II), Cu(II), Ni(II), Pb(II) and Zn(II) from the contaminated water.

The particulate cryptocrystalline magnesite may have a particle size such that the particulate cryptocrystalline magnesite is able to pass through a 125 μm particle size sieve, preferably through a 75 μm particle size sieve, more preferably through a 50 μm particle size sieve, most preferably through a 40 μm particle size sieve. The particulate cryptocrystalline magnesite may for example have a maximum particle size of about 32 μm so that it passes through a 32 μm particle size sieve.

The contaminated water may be contacted with cryptocrystalline magnesite at a solid/liquid ratio of 0.5 kg-10 kg:10 L-150 L, preferably at a solid/liquid ratio of 0.5 kg-5 kg:10 L-150 L, e.g. at a solid/liquid ratio of about 1 kg/100 L.

The contaminated water may be contacted with cryptocrystalline magnesite for 10 to 80 minutes, preferably 50 to 70 minutes. For the treatment of acid mine drainage in particular, the mixing time is 50 to 70 minutes, preferably about 60 minutes.

The contaminated water may be acid mine drainage.

The contaminated water may instead be industrial waste water containing metal or metalloid ions. The industrial waste water may comprise divalent metal ions. When the industrial waste water comprises divalent metal ions, the contaminated water is preferably contacted with cryptocrystalline magnesite for 20 to 40 minutes, e.g. about 30 minutes.

The divalent metal ions in the industrial waste water may be selected from the group consisting of Co(II), Cu(II), Ni(II), Pb(II) and Zn(II).

The oxyanions may be selected from the group consisting of sulphates, phosphates and nitrates. The process of the invention thus also removes sulphates and phosphates and nitrates from water.

The cryptocrystalline magnesite may be obtained at least in part from magnesite tailings from a cryptocrystalline magnesite mining operation, or may be obtained at least in part from a magnesite tailings dam.

The invention extends to powdered cryptocrystalline magnesite with a particle size such that the particulate cryptocrystalline magnesite is able to pass through a 125 μm particle size sieve for use in the treatment of water.

Preferably the powdered cryptocrystalline magnesite for use in the treatment of water has a particle size such that the particulate or powdered cryptocrystalline magnesite is able to pass through a 75 μm particle size sieve, more preferably through a 50 μm particle size sieve, most preferably through a 40 μm particle size sieve. The powdered or particulate cryptocrystalline magnesite may for example have a maximum particle size of about 32 μm so that it passes through a 32 μm particle size sieve.

The powdered cryptocrystalline magnesite for use in the treatment of water may comprise cryptocrystalline magnesite obtained at least in part from magnesite tailings from a cryptocrystalline magnesite mining operation, or obtained at least in part from a magnesite tailings dam.

### BRIEF DESCRIPTION OF THE DRAWINGS

The invention is now described by way of example with reference to the following examples and drawings.

In the drawings:

FIG. 1 is a flow diagram of one embodiment of a process in accordance with the invention;

FIG. 2 shows XRD patterns of raw (upper pattern) and reacted cryptocrystalline magnesite (lower pattern);

FIG. 3 shows spectrums by (FTIR) analysis of raw and AMD-reacted cryptocrystalline magnesite;

FIG. 4 is a graph showing the results for neutralization and metal removal efficiency as a function of contact time;

FIG. 5 is a graph showing the results for neutralization and metal removal efficiency as a function of cryptocrystalline magnesite dosage;

FIG. 6 is a graph showing the results for neutralization and metal removal efficiency of cryptocrystalline magnesite as a function of particle size;

FIG. 7 is graphs showing the results for neutralization and metal removal efficiency of cryptocrystalline magnesite as a function of metal concentration;

FIG. 8 is a graph showing the variation of pH gradient with varying Fe concentrations;

FIG. 9 is a graph showing the effect of shaking time on removal of Co(II), Cu(II), Ni(II), Pb(II) and Zn(II) using cryptocrystalline magnesite at varying time intervals;

FIG. 10 is a graph showing the effect of cryptocrystalline magnesite dosage on removal of Co(II), Cu(II), Ni(II), Pb(II) and Zn(II) at varying dosages;

FIG. 11 is a graph showing the effect of metal ions concentration on removal of Co(II), Cu(II), Ni(II), Pb(II) and Zn(II) using cryptocrystalline magnesite at varying species concentration;

FIG. 12 shows XRD patterns obtained by TEM, including a spectrum for run-of mine cryptocrystalline magnesite; and

FIG. 13 shows XRD patterns obtained by TEM, including a spectrum for synthesised cryptocrystalline magnesite.

### DESCRIPTION OF PREFERRED EMBODIMENTS

This invention relates to a process for the treatment of contaminated water, in particular the remediation of AMD, acidic, metalliferous and industrial waste water, using cryptocrystalline magnesite. According to the present invention, it has been found that cryptocrystalline magnesite neutralises acidic mine effluent and attenuates heavy load of metals from mine drainage and industrial waste water.

The most common method for removing metals from AMD is by precipitating the metals as hydroxides. According to the present invention, this may be achieved almost exclusively by the application of cryptocrystalline magnesite to the wastewater until the pH reaches the minimum solubility of the metals, (Equation 1-3 for Fe):

2Fe²⁺+1/2O₂+2H⁺=2Fe³⁺+H₂O (1)

2Fe³⁺+6H₂O→2Fe(OH)₃+6H⁺ (2)

2Fe²⁺+2O₃+2H⁺+3MgCO₃→2Fe(OH)₃+3Mg₂₊+H₂O+3CO₂ (3)

When this pH is reached, small particles of the metal hydroxide are formed as shown below:

Mⁿ⁺+nOH⁻→M(OH)ₙ↓ (4)

Magnesium forms a complex with sulphate in AMD solution. Due to the high solubility of MgSO₄ (Kₛₚ=5.9×10⁻³) compared to CaSO₄ (Kₛₚ=4.93×10⁻⁵), it is possible to keep sulphate in solution while precipitating metals as hydroxides or co-precipitating metals with sulphate.

Due to low solubility and ability to raise pH to >10, cryptocrystalline magnesite can be used for recovery of divalent species of Cu, Co, Ni, Pb and Zn from aqueous solution. This is appropriate in industries where metals recovery needs to be pursued.

With reference to FIG. 1, in a process of the invention, acid mine drainage (AMD) 10 is introduced into a mixing vessel 12 and mixed with pulverized cryptocrystalline magnesite 14. A specified amount of cryptocrystalline magnesite 14 is added to the vessel 12 with a specified amount of AMD 10 at an optimized liquid to solid ratio (S/L ratio). The mixture is stirred for a specified time interval. After mixing, the mixture 16 is sent to a filtration unit 18. Purified water 20, and a separated solid residue 22 are recovered from the filtration unit 18. The solid residue 22 is sent to a vessel 24 for the recovery of metals and the regeneration of cryptocrystalline magnesite.

For AMD, optimum treatment conditions are about 60 minutes of equilibration, 32 μm particle size, 250 rpm, 26° C. and 1 g of cryptocrystalline magnesite:100 mL of AMD solid to liquid ratio (S/L).

In an embodiment of the invention, divalent metal ions Co(II), Cu(II), Ni(II), Pb(II) and Zn(II) are removed from aqueous solutions using cryptocrystalline magnesite. Metals attenuation equilibrium was achieved at about 30 minutes and at a pH>10. Greater than 99% removal efficiencies were observed for all metal species under optimised conditions. A geochemical computer code predicted that metals existed as divalent species at pH<4 and they were removed as metal hydroxides. According to the present invention, cryptocrystalline magnesite can be used as an effective material for removal of divalent metal species from aqueous solutions containing these metals, such as industrial waste.

### EXAMPLES

Materials and Methods

Sampling

Run-of-mine cryptocrystalline magnesite rock was collected from the Folovhodwe Magnesite Mine in Limpopo Province South Africa. Field AMD samples were collected from a decant point in a disused mine shaft in Krugersdorp, Gauteng Province, South Africa.

Preparation of Cryptocrystalline Magnesite

Cryptocrystalline Magnesite samples were milled to a fine powder for 15 minutes at 800 rpm using a Retsch RS 200 vibratory ball mill and passed through a 32 μm particle size sieve.

Characterisation of Aqueous Samples

pH, Total Dissolved Solids (TDS) and Electrical Conductivity (EC) were monitored using CRISON MM40 portable pH/EC/TDS/Temperature multimeter probe. Aqueous samples were analysed using ICP-MS (7500ce, Agilent, Alpharetta, Ga., USA) for metal cations and sulphate was analysed using IC (850 professional IC Metrohm, Herisau, Switzerland). The accuracy of the analysis was monitored by analysis of National Institute of Standards and Technology (NIST) water standards. Three replicate measurements were made on each sample and results are reported as mean of the three samples.

Chemical and Microstructural Characterization

Mineralogical composition of composite and resulting solid residues was determined using XRD, Analysis were performed by using a Philip PW 1710 diffractometer equipped with graphite secondary monochromatic. Elemental composition was determined using XRF, the Thermo Fisher ARL-9400 XP+ Sequential XRF with WinXRF software. Morphology was determined using SEM-EDS (JOEL JSM-840, Hitachi, Tokyo, Japan). Functional groups were determined using Perkin-Elmer Spectrum 100 Fourier Transform Infrared Spectrometer (FTIR) equipped with a Perkin-Elmer Precisely Universal Attenuated Total Reflectance (ATR) sampling accessory equipped with a diamond crystal. Carbon and Sulphur were determined using ELTRA CS-800 carbons/sulphur analyser from ELTRA GmbH (Retsch-Allee 1-542781, Haan, Germany).

Formulation of Synthetic AMD

Synthetic acid mine drainage (SAMD) was used for the batch optimization experiments as real acid drainage is unstable over long periods of time due to oxidation and hydrolysis which change its chemistry. A simplified solution containing the major ions found in acid mine waters was prepared and is characterized in Table 1 below.

TABLE 1

| Salt dissolved | Species | Concentration | |
|---|---|---|---|
| Al₂(SO₄)₃•18H₂O | Al³⁺ | 200 | mg/L |
| Fe₂(SO₄)₃•H₂O | Fe³⁺ | 2000 | mg/L |
| MnCl₂ | Mn²⁺ | 100 | mg/L |
| H₂SO₄ and Al and Fe salts | SO₄²⁻ | 6000 | mg/L |

Synthetic AMD solution was simulated by dissolving the following quantities of salts (7.48 g Fe₂(SO₄)₃.H₂O, 2.46 g Al₂(SO₄)₃.18H₂O, and 0.48 g MnCl₂ from Merck, 99% purity) in 1000 mL of Merck Millipore Milli-Q 18.2 MΩ·cm water to give a solution of 2000 mg/L Fe³⁺, 200 mg/L Al³⁺ and 200 mg/L Mn²⁺. 5 mL of 0.05 M H₂SO₄ was added to make up SO₄²⁻ concentration to 6000 mg/L and ensure pH below 3 and in order to prevent immediate precipitation of ferric hydroxide. The SAMD was prepared with deionized water. The salts were dissolved in 1000 mL volumetric flask.

Geochemical Modelling

To complement chemical solution and physicochemical characterization results, the ion association model PHREEQC was used to calculate ion activities and saturation indices of mineral phases based on the pH and solution concentrations of major ions in supernatants that were analysed after the optimized conditions. Mineral phases that were likely to form during treatment of AMD were predicted using the PHREEQC geochemical modelling code using the WATEQ4F database (Park-hurst and Appelo, 1999). Species which are more likely to precipitate were determined using saturation index (SI). SI<1=under saturated solution, Si=1=saturated solution and SI>1=Supersaturated solution.

### Example 1

### Treatment of AMD with Cryptocrystalline Magnesite

To establish the optimum condition for AMD treatment, several operational parameters were investigated and these include: time, dosage of cryptocrystalline magnesite, species concentration and particle size.

1.1 Effect of Time

Aliquots of 100 mL SAMD were pipetted into 250 mL flasks into which 1 g of cryptocrystalline magnesite samples were added. The mixtures were then equilibrated for 1, 10, 20, 60, 120, 180, 240, 300 and 400 minutes at 250 rpm using a Stuart reciprocating shaker. After shaking, the mixtures were filtered through a 0.45 μm pore nitrate cellulose filter membrane. After filtration each sample was divided into two for anion and cation analysis. For cations, the filtrates were preserved by adding two drops of concentrated HNO₃ acid to prevent aging and precipitation of Al, Fe and Mn and refrigerated at 4° C. prior to analysis by an ELAN 6000 inductively coupled plasma mass spectrometer (ICP-MS) (PerkinElmer, USA). For anion analysis the samples were stored in a fridge until analysis by Professional Ion Chromatography Metrohm model 850 (Switzerland). The pH before and after agitation was measured using the CRISON multimeter probe (model MM40).

1.2 Effect of Dosage

Aliquots of 100 mL each of multicomponent SAMD were pipetted into 250 mL flasks and varying masses (0.1 g, 0.5 g, 1 g, 2 g, 3 g, 4 g, 5 g, and 8 g) of pulverized cryptocrystalline magnesite added into each flask. The mixtures were agitated using a shaker for 60 min at 250 rpm using a table shaker. The pH and metal content were measured as described in the preceding section.

1.3 Effect of Species Concentration

To investigate the effects of adsorbate concentration on reaction kinetics, several dilutions were made from the stock solution. The pH of the simulated AMD was not adjusted. The capacity of the adsorbent to neutralize and attenuate metals from aqueous solutions was then assessed by increasing metal concentrations. Solutions of 100 mL each of the SAMD were prepared in triplicate and 1 g of cryptocrystalline magnesite added to each sample container. The initial pH of the working solutions was maintained at pH<3.

1.4 Effect of Particle Size

Aliquots of 100 mL each of SAMD were pipetted into 250 mL flasks and 1 g of varying particle sizes (ranging from 1-2000 μm) of cryptocrystalline magnesite added into each flask. The mixtures were agitated using a reciprocating shaker for an optimum time of 60 min at 250 rpm.

1.5 Treatment of Field AMD at Optimized Conditions

Field AMD samples were treated at established optimized conditions in order to assess the effectiveness of cryptocrystalline magnesite. pH, EC and TDS were measured using CRISON MM40 multimeter probe. The resultant solid residue after treatment of raw AMD was characterized in an attempt to gain an insight as to the fate of chemical species.

Results

Mineralogy, Elemental and Microstructural Characterization

1.6 X-Ray Diffraction Analysis

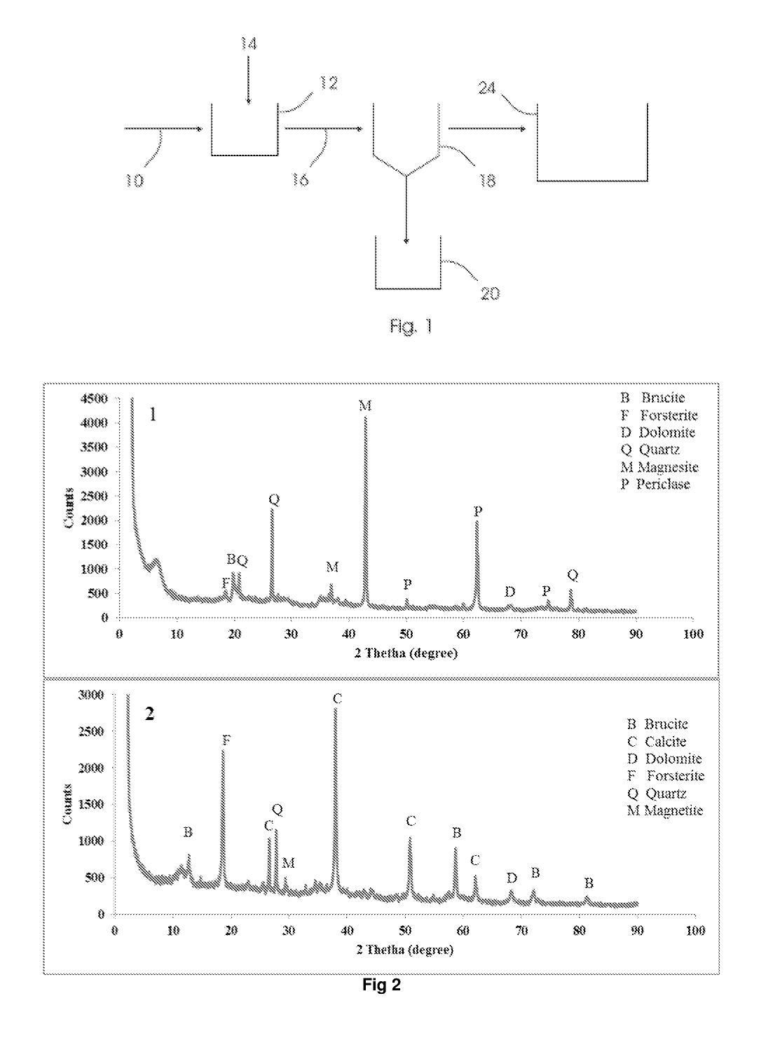

The mineralogical compositions by XRD, for raw and reacted cryptocrystalline magnesite, with field AMD, are presented in FIG. 2. FIG. 2 shows the crystalline phases on raw and reacted cryptocrystalline magnesite.

The results revealed that raw cryptocrystalline magnesite mainly consists of cryptocrystalline magnesite, periclase, brucite, dolomite, forsterite and quartz as the crystalline phases. After treatment of field AMD, the following minerals were detected in the reacted cryptocrystalline magnesite: brucite, calcite, and magnetite. As calcite, dolomite, brucite and magnetite were observed to be present, conditions were suitable for precipitation of Ca, Mg and Fe bearing species (pH>10). The peak of periclase was observed to be absent in the secondary residues hence indicating the dissolution of MgO. This was also predicted from geochemical modelling simulations. The precipitation of calcite and brucite from AMD can be represented by the following equation:

Mg²⁺+H₂O+CO₃²⁻→Mg(OH)₂+CO₂↑ (5)

MgCO₃+H₂O→Mg(OH)₂+H₂CO₃ (6)

Ca²⁺+2HCO₃⁻→CaCO₃↓+H₂CO₃ (7)

Magnesium will react with water and carbonate in AMD to precipitate as brucite at pH>10 (Equation 5 and 6). Ca²⁺ in AMD will react with carbonic acid in water to form calcium carbonate (Equation 7). Cryptocrystalline magnesite will react with sulphuric acid in AMD to form magnesium sulphate, water and carbon dioxide as shown in Equation 8 below:

MgCO₃+H₂SO₄→MgSO_{4(aq)}+H₂O+CO₂↑(8)

Periclase will react with acidity in AMD to give magnesium ions and hydroxyl ions

MgO+H⁺→Mg²⁺+OH⁻ (9)

Brucite will react with acidity in AMD to form magnesium ions and water

MgOH⁺+H⁺→Mg²⁺+H₂O (10)

Silicate will react with acidity in AMD through ion exchange and leads to pH increase

≡SiOH↔SiO⁻+H⁺ (11)

≡SiOH+Ca²⁺↔═SiOCa+H⁺ (12)

≡SiOCa+M²⁺+2HOH→═SiOM+Ca²⁺+2OH⁻ (13)

1.7 Carbon and Sulphur Determination by ELTRA

ELTRA analytical technique revealed that cryptocrystalline magnesite contains 6% of carbon on raw material and 8% elemental composition post interaction with AMD. This shows that the material understudy is a carbonate. An increase in carbon may be attributed to precipitation of carbonate at pH>10. Sulphur content was recorded to be 0.002% on raw cryptocrystalline magnesite and 0.97% on reacted cryptocrystalline magnesite hence confirming that cryptocrystalline magnesite is a sink of sulphate from AMD. This has corroborated XRF, FTIR, SEM-EDS and PHREEQC geochemical modelling.

1.8 X-Ray Fluorescence Analysis

The elemental composition of cryptocrystalline magnesite before and after interaction with field AMD is shown in Table 2.

TABLE 2
Elemental composition (wt %) of cryptocrystalline
magnesite before and after treatment with AMD

| | Cryptocrystalline | AMD-crypto- |
|---|---|---|
| Sample | magnesite | crystalline magnesite |
| SiO₂ | 6.09 | 5.25 |
| Al2O3 | 0.71 | 0.63 |
| Fe₂O₃ (t) | 0.54 | 2.47 |
| MnO | 0.01 | 0.45 |
| MgO | 82.09 | 60 |
| CaO | 2.39 | 4.91 |
| Na₂O | 0.13 | 0.11 |
| K₂O | 0.06 | 0.05 |
| SO₃ | 0.2 | 10 |
| LOI | 7.34 | 19.05 |
| Total | 99.56 | 100 |
| H₂O— | 1.62 | 2 |
| Ppm | | |
| As | <4 | 9 |
| Ba | <5 | 8.9 |
| Br | 2.5 | <2 |
| Co | <1 | 6.2 |
| Cr | 3.9 | 16 |
| Cu | 6.2 | 11.3 |
| Ga | 1.1 | 1.9 |
| Hf | 8.8 | 10.3 |
| Nb | 158 | 225 |
| Ni | 11 | 137 |
| Pb | 4 | 21 |
| Se | 11 | 21 |
| Sr | 5.4 | 84 |
| Ta | 4.3 | 22 |
| Y | 2 | 32 |
| Zn | 1 | 39 |
| Zr | <2 | 5.5 |

After the reaction, Zn, Cu, Co, Nb, Ni, Pb, SO₃, Sr, Y, Zr, Cr and Ba were found to be present in the resultant solid residues. The levels of Al, Fe, Mg, Ca, Mn and S were observed to increase in the resultant solid residues indicating formation of new phases. The XRF results are confirming the XRD (FIG. 2) results as reported above.

1.9 Fourier Transforms Infrared Spectroscopy (FTIR) Analysis

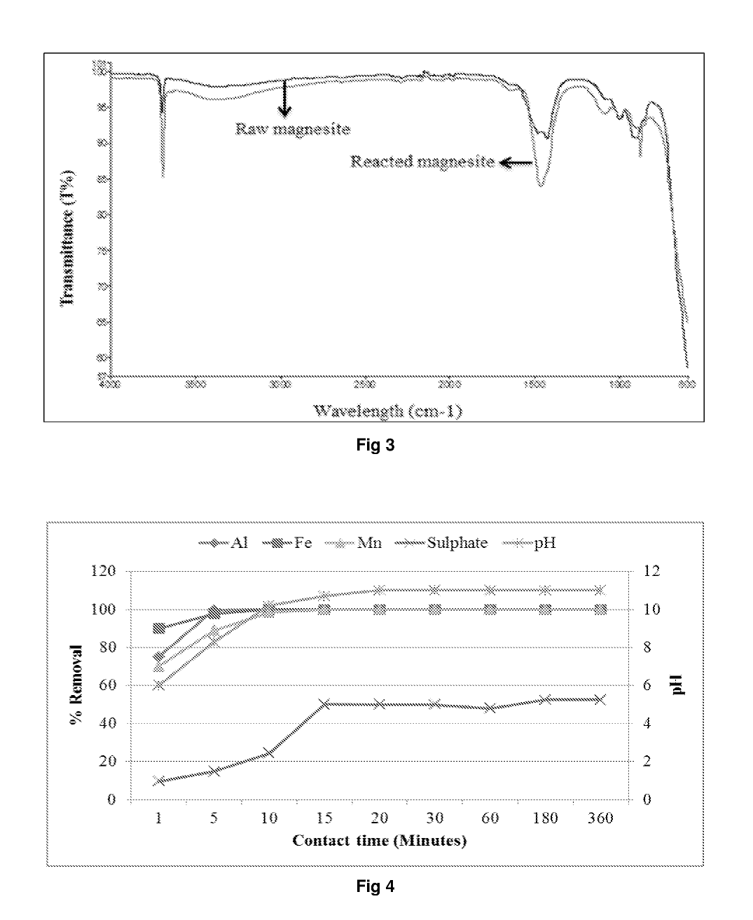

The spectrum of raw and AMD-reacted cryptocrystalline magnesite, are shown in FIG. 3.

Spectroscopic studies confirm the results of XRD studies. The system of bands in raw cryptocrystalline magnesite is characterised of brucite bending corresponding to band 3702 cm⁻¹, periclase stretches corresponding to band 1500 and 950 cm⁻¹ and cryptocrystalline magnesite stretching vibration corresponding to bands 1680, 1450, 850 cm⁻¹. The doublet at 1490, 1419 cm⁻¹ corresponds to asymmetric stretching vibrations of carbonate. The reason for the split of this peak into a doublet could be due to the formation of new carbonates such as CaCO₃ and MgCO₃. The band at 1117 cm⁻¹ corresponds to symmetric stretching of carbonate, and those at 886, 795 cm⁻¹ are assigned to in-plane and out-of-plane bending vibrations of carbonate ion. The presence of carbonates in raw cryptocrystalline magnesite suggests the presence of cryptocrystalline magnesite and calcite. The presence of carbonates in reacted cryptocrystalline magnesite suggests the precipitation of rhodochrosite, siderite, calcite and dolomite. The system of bands for reacted cryptocrystalline magnesite is characteristic of brucite stretches corresponding to band 3702 cm⁻¹; bands at 3600-3700 are associated with OH groups and adsorbed water and new bands corresponding to calcite stretches at band 630 cm⁻¹ and magnetite at band 880 cm⁻¹. FTIR results provide evidence that cryptocrystalline magnesite is acting as a sink of inorganic contaminants from aqueous solution. These results corroborate results obtained by XRD (FIG. 1) and XRF (Table 2).

1.10 Effects of Equilibration Time

The results for neutralization and metal removal efficiency as a function of contact time are presented in FIG. 4. FIG. 4 shows variation of Al, Fe, Mn and SO₄²⁻ with time and pH (2000 mg/L Fe³⁺, 200 mg/L Al³⁺, 100 mg/L Mn²⁺, 6000 mg/L SO₄²⁻, 1 g cryptocrystalline magnesite, 32 μm, 250 rpm and 26° C.).

The results for neutralization and metal removal efficiency function revealed that there was an increase in pH with increasing contact time. The pH increased significantly from 1.8 (initial pH of AMD) to 10, approaching a steady state at 60 minutes. An increase in pH may have been due to the consumption of H⁺ from sulphuric acid by cryptocrystalline magnesite, contributing to the elevation of pH. Moreover, there was elevated removal of Al (93-100%), Fe (95-100%) and Mn (98-100%) after 20 min, suggesting precipitation, adsorption and/or co-precipitation. This was attributed to an increase in the pH of the solution, resulting in Fe precipitating at pH>3, Al at pH>4 and Mn at pH>9.

1.11 Effect of Dosage

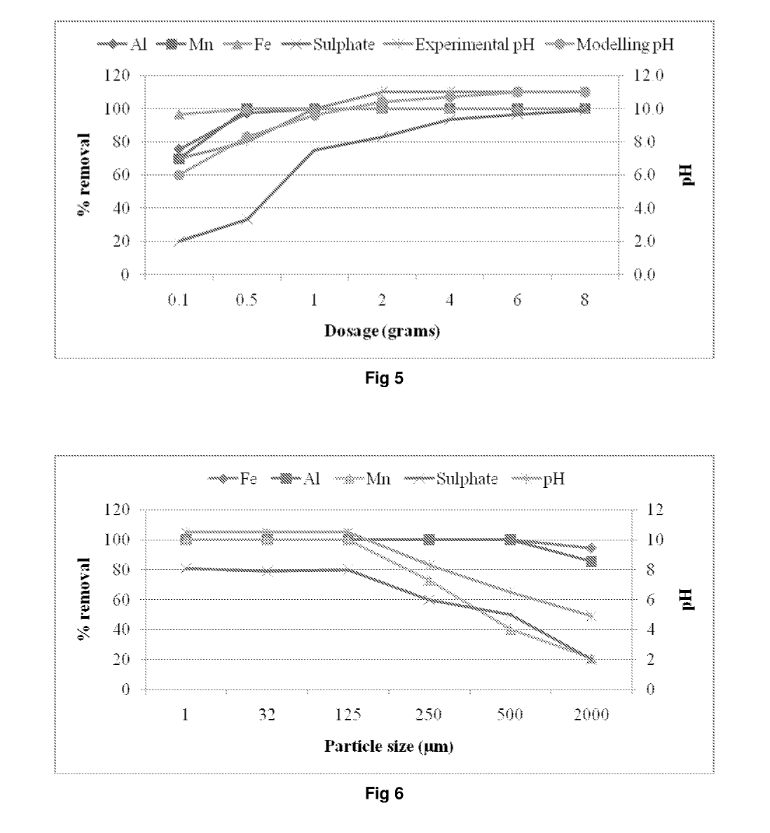

The results for neutralization and metal removal efficiency as a function of cryptocrystalline magnesite dosage are presented in FIG. 5. FIG. 5 shows variation of pH, Al, Fe, Mn and sulphate concentrations in AMD with adsorbent dosage (2000 mg/L Fe³⁺, 200 mg/L Al³⁺, 100 mg/L Mn²⁺, 6000 mg/L SO₄²⁻, 250 rpm, 60 min reaction time, <32 μm particles size and 26° C.)

The experimental results showed that there was an increase in pH with increase in dosage. PHREEQC showed an increase in alkalinity from −3.648×10⁻¹⁵ to 3.497 (eq/Kg). An increase in pH results from dissolution and hydrolysis of components such as MgO, Mg(OH)₂ and MgCO₃ (Equation 14-16).

MgO+H₂O→Mg²⁺+2OH⁻ (14)

MgCO₂+H₂O→Mg²⁺+2OH⁻+CO₂↑ (15)

Mg(OH)₂+H₂O→MgOH⁺+H₂O+OH⁻ (16)

Modelling predicted that as pH increases, Fe³⁺ species precipitate at pH>6, Al³⁺ bearing species at pH>6, Fe²⁺ species at pH>8 and Mn²⁺ bearing species at pH>10. The trend showed a smaller % removal of sulphate compared to that of metals. This was attributed to association of Mg and SO₄ and partly, CaSO₄ that remain in solution until saturation is attained leading to precipitation at elevated dosages. This is substantiated by the higher solubility of MgSO₄ (Kₛₚ=5.9×10⁻³) compared to that of CaSO₄ (Kₛₚ=4.93×10⁻⁵), suggesting that more magnesium would be required to be in solution to precipitate MgSO₄. Metal complexes were predicted to precipitate as hydroxide, oxyhydroxides and oxyhydroxysulphates. From the dosage experiments, it was concluded that optimum neutralization and metal attenuation conditions were about 1:100 solid/liquid ratios.

1.12 Effect of Particle Size

The results for neutralization and metal removal by cryptocrystalline magnesite, as a function of particle size, are presented in FIG. 6. FIG. 6 shows variation of Al, Fe, Mn, SO₄²⁻ and pH as a function of cryptocrystalline magnesite particle size (2000 mg/L Fe³⁺, 200 mg/L Al³⁺, 100 mg/L Mn²⁺, 6000 mg/L SO₄²⁻, 1 g cryptocrystalline magnesite, 100 mL solution, 250 rpm and 26° C.).

Particle size is an important parameter in neutralization and metal attenuation processes. As shown in FIG. 6, the rate of neutralization and metal attenuation decreased with increasing particle size. At particle sizes <125 μm, Al, Mn, Fe and sulphate were completely removed. Particles with size >125 μm were observed to significantly increase the pH of the aqueous solution. This study is comparable to those for calcium-based materials, for instance, with limestone, where pH values of 6 and higher were achieved with particle sizes of 300 μm and smaller, whereas particle sizes of 500 μm and smaller for cryptocrystalline magnesite were used to achieve pH>6. Thus, the efficiency of cryptocrystalline magnesite was found to be better than limestone.

1.13 Effect of Chemical Species Concentration

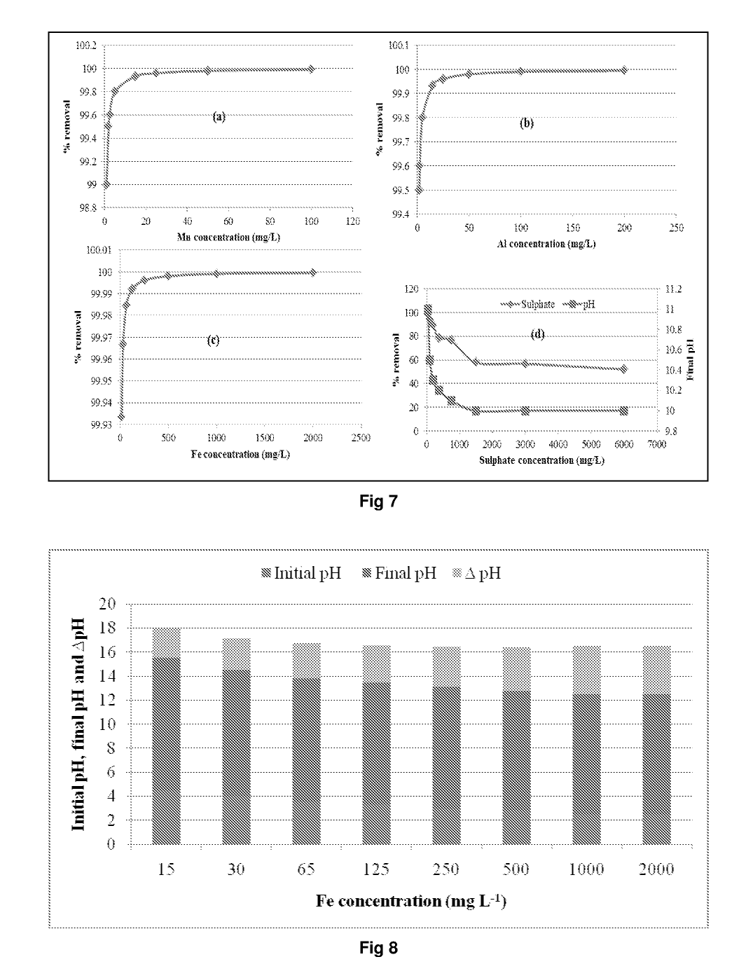

The results for neutralization and metal removal efficiency of cryptocrystalline magnesite as a function of metal concentration are presented in FIG. 7. FIG. 7 shows (a) variation in % removal of Mn²⁺ as a function of species concentration. (b) variation in % removal of Al³⁺ as a function of ion concentration and (c) variation in % removal of Fe³⁺ as a function of ion concentration and (c) variation in % removal of SO₄²⁻ as a function of concentration (60 min, 1 gram, 1:100 S/L ratios, 32 μm, 250 rpm and 26° C.). Removal of Mn is independent of Mn and Al concentrations for the range tested because the pH was high enough to precipitate all the metals. From FIG. 7(c), the removal of Fe from SAMD is gradually decreasing with an increase in Fe concentration because the pH was high enough to precipitate all the metals. From FIG. 7(d), the removal of sulphate was observed to gradually decrease with an increase in sulphate concentration. As sulphate concentration increased, the pH of the solution decreased. As shown in FIG. 8, drastic increases in pH were observed at varying Fe concentrations. An increase in pH was attributed to dissolution of calcite, periclase, brucite and dolomite as shown by XRD.

1.14 Variation of pH with an Increase in Fe³⁺ Concentration

The decrease in pH with an increase in adsorbate concentration is due to hydrolysis of metal species cations leading to release of H⁺. The hydrolysis of Fe³⁺ and Al³⁺ releases protons and offsets the pH of the solution (Equation 17 and 18 and FIG. 8).

Fe³⁺+3H₂O→Fe(OH)₃₍ₛ₎+3H⁺ (17)

Al³⁺+3H₂O→Al(OH)₃₍ₛ₎+3H⁺ (18)

The variation of pH profile with varying concentration of Fe³⁺ as representative of the inorganic contaminants in the SAMD is shown in FIG. 8.

1.15 Calculation of Saturation Indices (SI) for Various Mineral Phases

The results for calculation of mineral precipitation at various pH values during treatment of simulated AMD with cryptocrystalline magnesite are presented in Table 3.

TABLE 3
Calculation of SI for selected mineral phases at various pH

| | pH and saturation indices (SI) | | | | | |
|---|---|---|---|---|---|---|
| Mineral phase | 3 | 4 | 6 | 8 | 10 | 11 |
| Alkalinity (eq/Kg) | −3.6 × 10⁻² | 1.5 × 10⁻² | 6.4 × 10⁻² | 3 × 10⁻¹ | −3 × 10⁻¹ | 3.5 |
| Al(OH)₃ | −0.9 | 3.5 | 2.9 | 1.2 | −0.1 | −1.5 |
| Boehmite (AlOOH) | −0.5 | 7 | 5 | 3.4 | 2.1 | 0.7 |
| Basaluminite Al₄(OH)₁₀SO₄ | −0.8 | 23 | 17.4 | 6 | −1.4 | −10.2 |
| Brucite Mg(OH)₂ | −11 | −9 | −6.6 | −2 | 0.6 | 3.6 |
| Calcite | −11 | −2.3 | −1.5 | 1.8 | 3.4 | 4 |
| Aragonite | −8.6 | −2.5 | −0.2 | 1.7 | 3.7 | 3.8 |
| Diaspore (AlOOH) | −0.9 | 8.3 | 6.8 | 5.1 | 3.1 | 2 |
| Dolomite CaMg(CO₃)₂ | −6 | −2.5 | −1.3 | 4.9 | 6.9 | 8 |
| Epsomite | −7 | −4 | −2 | −1.8 | −1.8 | −1.8 |
| Fe(OH)₃ | 5 | 4.4 | 3.7 | 4.6 | 3.2 | 3.1 |
| Gibbsite Al(OH)₃ | 0.3 | 6.7 | 5.5 | 3.7 | 1.8 | 0.8 |
| Geothite (FeOOH) | 6 | 8 | 9.7 | 10.5 | 9.1 | 9 |
| Gypsum (CaSO₄•H₂O) | −0.1 | −0.2 | −0.2 | 4 | 5 | 8 |
| Jarosite H | 5 | 3.2 | 2.9 | −3.7 | −16 | −20 |
| (H₃O)Fe₃(SO₄)₂(OH)₆ | | | | | | |
| Jurbanite (AlOHSO₄) | 1 | 5 | 2.5 | −3.6 | −9.8 | −12.8 |
| Rhodochrosite (MnCO₃) | −8.75 | −0.9 | −0.4 | 0 | 0 | 0 |
| Manganite MnOOH | −8.1 | −5.3 | −2.9 | 4 | 6 | 8 |
| Pyrochroite Mn(OH)₂ | −8 | −7.1 | −6.4 | 0.2 | 0.9 | 2.2 |

Most of the Al and Fe could precipitate as hydroxides at pH>6. Mn could precipitate as manganese hydroxide at pH>10 and rhodochrosite at pH>8. Sulphate-bearing minerals could precipitate at pH 6-8 (basaluminite), pH>8 (gypsum), pH 6 (jarosite and jurbanite). Generally, mineral phases were predicted to precipitate as metal hydroxides, hydroxysulphates and oxyhydroxysulphates. Epsomite (MgSO4) was observed to be near precipitation but it did not precipitate and may this be attributed to the high solubility of epsomite (Kₛₚ=5.9×10⁻³). However, sulphates were removed from solution together with Al, Fe and Ca. This corroborate the SEM-EDX and XRF detected Al, Fe, Mn and S rich mineral phases that were deposited to solid residues. This indicates that the Al, Fe, Mn and S rich mineral phases were too amorphous to be detected by XRD or the concentration was below the detection limits.

1.16 Treatment of Field AMD Samples

TABLE 4
Chemical and physical characteristics of AMD samples
used in the experiments (Units: mg/L except pH and EC).

| | Feed | DWAS | Cryptocrystalline |
|---|---|---|---|
| Parameter | AMD water | Guidelines | magnesite treated AMD |
| Ph | 2.3 | 6-10 | 10.3 |
| TDS | 10237 | 0-1200 | 4345.2 |
| EC | 22713 | 0-700 | 4635.6 |
| Na | 171 | 0-50 | 164 |
| K | 18 | NA | 17 |
| Mg | 183 | 0-30 | 402 |
| Ca | 762 | 0-32 | 302 |
| Al | 190 | 0-0.9 | <0.03 |
| Fe | 259 | 0-0.1 | <0.02 |
| Mn | 40 | 0-0.05 | 0.04 |
| Cu | 7.80 | 0-1 | <0.05 |
| Zn | 7.90 | 0-0.5 | 0.1 |
| Pb | 6.30 | 0-0.01 | 0.2 |
| Co | 41.30 | NA | 0.2 |
| Ni | 16.60 | 0-0.07 | 0.5 |
| As | 20 | 0.001 | <0.01 |
| B | 5 | 0.01 | <0.01 |
| Cr | 20 | 0.01 | <0.01 |
| Mo | 16 | 0.01 | <0.01 |
| Se | 17 | 0.02 | <0.01 |
| Si | 1.49 | NA | 5.7 |
| SO₄²⁻ | 4000 | 0-500 | 1913 |

DWAS = South African Department of Water Affairs and Sanitation

The pH of the wastewater used in this study was 3. Acidity was quantified to be 200 mg/L as CaCO₃. Total dissolved solids (TDS) and electrical conductivity (EC) were 240 mg/L and 403 μS/cm respectively. This is attributed to a large quantity of dissolved metal species and sulphates. The sulphate recorded in this sample was 4635 mg/L making this anion dominant. Major cations included Na, Ca, Mg, Al, Mn and Fe. The predominance of Fe and SO₄ indicates that this mine water was subjected to pyrite dissolution. Dissolution of silicate minerals such as feldspar, kaolinite, and chlorite accounts for most or all of the dissolved K, Na, Mg, Al and Ca. Traces of gold associated minerals such as Cu, Pb, Zn, Co, Ni, As, B, Cr, Mo and Se were also observed to be present. Post treatment, only Na, Mg and sulphate remained at elevated concentrations. Saturation indices from geochemical simulations suggested that Mg was below precipitation levels. Mg species form relatively high solubility salts hence are expected to largely remain in solution. Ca was reduced significantly and it was predicted to precipitate as gypsum, calcite and dolomite. The simulations showed that in the feed water, Fe existed mainly as Fe²⁺ and Fe³⁺ while the rest of the metals, except for Na and K, were in their divalent states at acidic solution. A large proportion of Mg existed as aqueous MgSO₄. From these results, the treated water is suitable for agricultural use, especially in acidic soils owing to its elevated pH. Most of the water quality parameters of the treated water fell within those stipulated by the South African Department of Water Affairs and Sanitation (DWAS) Water Quality Guidelines for irrigation (Table 4).

### CONCLUSION

This study has shown that cryptocrystalline magnesite can be used to remediate AMD. Contact of AMD with cryptocrystalline magnesite led to an increase in pH and a notable reduction in metal and sulphate concentrations. Removal of Al, Mn, Fe and other metals was maximized after 60 min of agitation for a S: L ratio of 1 g: 100 mL and particle size ranging from 0.1-125 μm. Under these conditions, the pH achieved was >10, an ideal regime for metal removal. Using geochemical modelling, it was shown that most metals e.g. Fe, Al, Mn, and Ca formed sulphate-bearing minerals. From modelling simulations, the formation of these phases follow a selective precipitation sequence with Fe³⁺ at pH>6, Al³⁺ at pH>6, Fe²⁺ at pH>8, Mn²⁺, Ca²⁺ and Mg²⁺ at pH>10. This study has pointed to the efficiency of cryptocrystalline magnesite in neutralizing and attenuating metals from AMD and metalliferous industrial effluents.

### Example 2

### Treatment of Water containing Divalent Metal Ions Co(II), Cu(II), Ni(II), Pb(II) and Zn(II)

2.1 Investigation of Metal Removal Conditions

Stock solution of 1000 ppm of Co(II), Cu(II), Ni(II), Pb(II) and Zn(II) prepared as one multicomponent solution using ultrapure water from Lab Consumables and Chemical Supplies (South Africa) was used for this study. The working solutions were prepared from this stock solution by appropriate dilutions for the batch experiments. The pH of the solution was maintained at pH<3 by addition of three drops of nitric acid. To study the effects of agitation time, the contact time was varied from 1-60 minutes. To evaluate the effects of dosage on reaction kinetics, the dosage was varied from 0.1-5 grams. To evaluate the effect of metal ions concentration, the concentrations were varied from 0.1-1000 mg/L. Optimum conditions established were applied for the removal of metal species in field wastewaters.

2.2 Treatment of Synthetic and Field Wastewater at Optimized Conditions

Wastewaters emanating from mining activities were treated at established optimized conditions in order to assess the effectiveness of cryptocrystalline magnesite to remove metals from synthetic and field metal rich water. The pH and metal species content were determined as described previously. pH, EC and TDS were measured using CRISON MM40 multimeter probe.

Results and Discussion

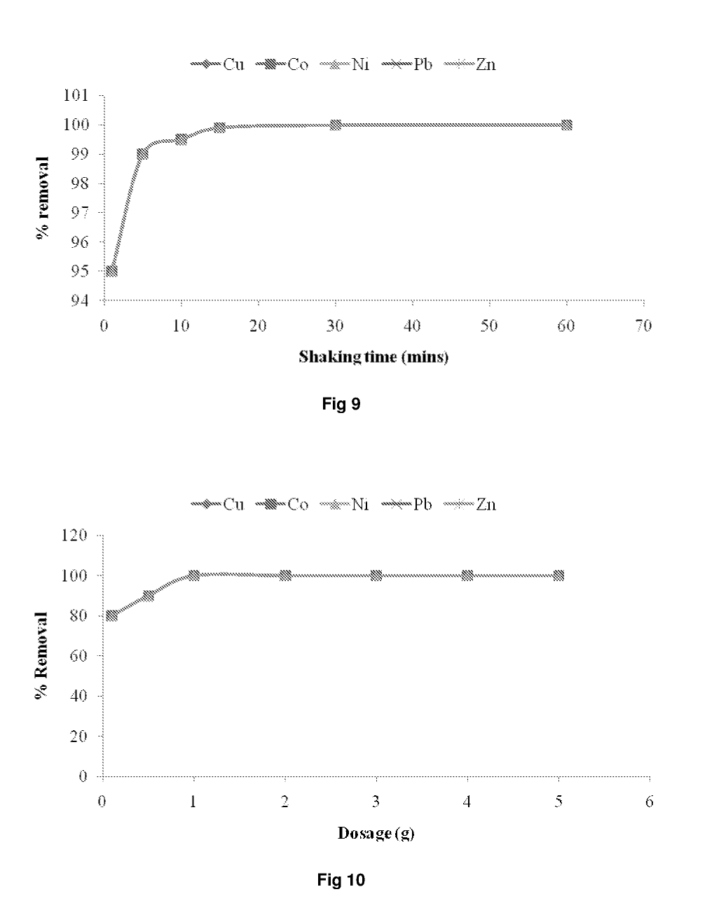

Optimum condition for removal of divalent metal species from aqueous solution is reported in FIGS. 9-11.

2.3 Effect of Agitation Time

The effect of agitation time on removal of Co(II), Cu(II), Ni(II), Pb(II) and Zn(II) using cryptocrystalline cryptocrystalline magnesite was investigated at varying time intervals ranging from 1-60 minutes (FIG. 9).

As can be seen in FIG. 9, there was an increase in percentage removal of divalent metals with an increase in contact time. From 0-30 minutes, there was a drastic removal of metal species from aqueous solution. Thereafter, no significant change in percentage removal was observed hence showing that 30 minutes was adequate for removal of divalent metal species from aqueous solution. As such 30 minutes were taken as an optimum shaking time and was applied for subsequent experiments.

2.4 Effect of Cryptocrystalline Magnesite Dosage

The effect of cryptocrystalline magnesite dosage on removal of Co(II), Cu(II), Ni(II), Pb(II) and Zn(II) using cryptocrystalline magnesite was investigated at varying grams of dosages ranging from 0.1-5 g (FIG. 10).

As shown in FIG. 10, there was an increase in percentage removal of divalent metal species with an increase in cryptocrystalline magnesite dosage. From 0.1-1 gram, there was a drastic removal of metal species from aqueous solution. A drastic removal of metals may be attributed to an increase in pH. Thereafter, no significant change in percentage removal was observed hence showing that 1 g would be adequate for removal of metal species from aqueous solution. One g and 100 mL solution were taken as the optimum dosage and solid to liquid ratios and were applied in subsequent experiments.

2.5 Effect of Metal Ions Concentration

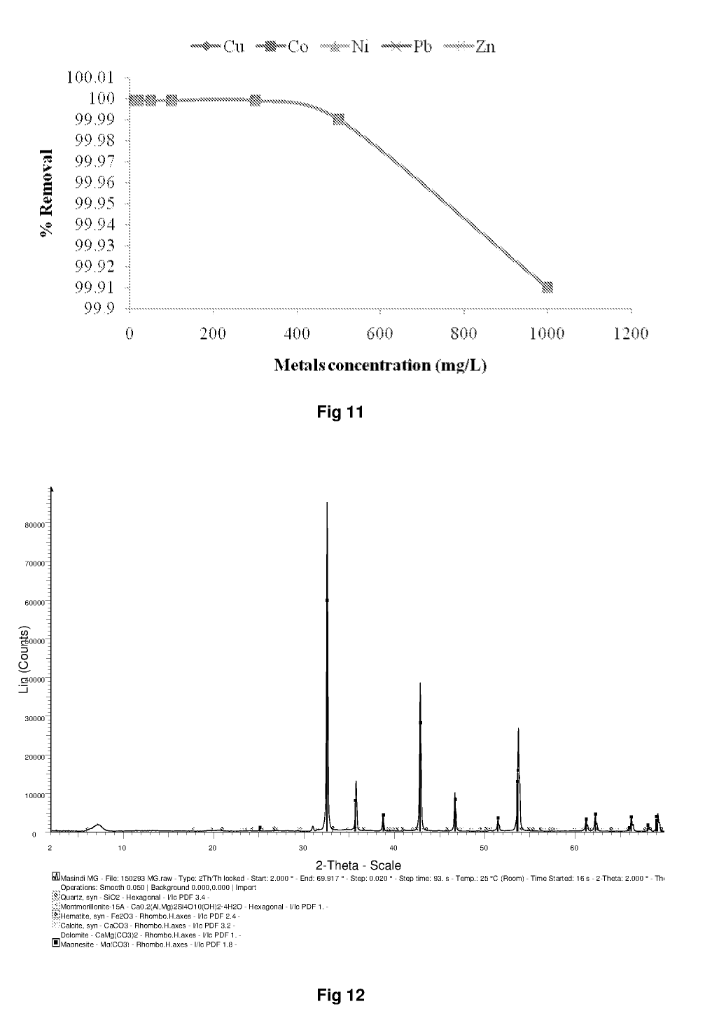

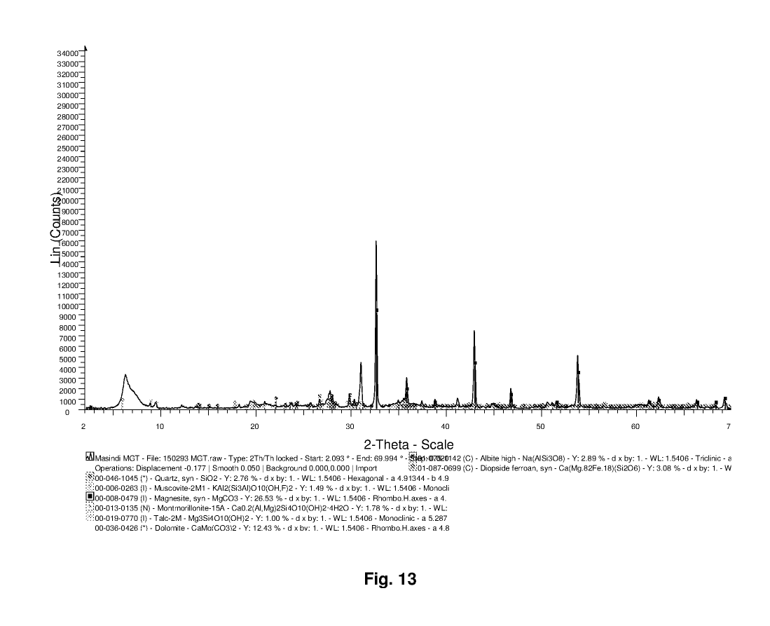

The effect of metal ions concentration on removal of Co(II), Cu(II), Ni(II), Pb(II) and Zn(II) using cryptocrystalline magnesite was investigated at varying species concentration ranging from 0.1-1000 mg (FIG. 11).

As shown in FIG. 11, there was a slight decrease in percentage removal of metals with an increase in chemical species concentration. From 0.1-1000 mg/L, the removal of metals species was greater than 99% hence showing that cryptocrystalline magnesite raised the pH to the level that enable precipitation of divalent metals species. As such, it can be concluded that cryptocrystalline magnesite can remove divalent metal species from aqueous solution to a level of up to 1000 mg L⁻¹.

2.6 Simulation of Mineral Precipitation during Treatment of Mine Leachates

The results for geochemical modeling calculations of saturation indices for metal hydroxides that are likely to precipitate at various pH values during the interaction of the metalliferious AMD with cryptocrystalline magnesite are presented in Table 5.

TABLE 5

pH

| Mineral phase | 3 | 6 | 7 | 8 | 9 | 10 |
|---|---|---|---|---|---|---|
| Co(OH) | −6.1 | −0.8 | 1.6 | 2.4 | 4.5 | 4.8 |
| Cu(OH) | −5.5 | 1.4 | 2.1 | 2.6 | 2.6 | 2.6 |
| Ni(OH) | −5.8 | 1.4 | 2.7 | 4.6 | 6.6 | 7.5 |
| Pb(OH) | −5.6 | 1.7 | 2.8 | 3.9 | 4.6 | 5.2 |
| Zn(OH) | −8 | −0.6 | 0.4 | 1.8 | 2.8 | 3.6 |

PHREEQC simulation revealed that Co(II), Cu(II), Ni(II), Pb(II) and Zn(II) remain in their divalent state in aqueous solution at pH<4. Table 5 shows the minerals that would be expected to precipitate at various pH values during the treatment of metals loaded solution with cryptocrystalline magnesite. All chemical species precipitated as metal hydroxides. The precipitation sequence varied as follow: Pb, Ni and Cu at pH>6, Zn and Co at pH>7 and Mg (not shown in Table 5) at pH>10. This will be a good approach especially when metals recovery needs to be pursued.

Cryptocrystalline magnesite was used to treat synthetic and field wastewater and the product water quality compared to South African government (DWAS) water quality guidelines for irrigation (Table 6).

TABLE 6

| Chemical | DWAS | Field | | | |
|---|---|---|---|---|---|
| species | guideline | Wastewater | Treated | Synthetic | Treated |
| pH | 6-10 | <4 | 10 | <3 | 10 |
| Cu | <5 | 7.8 | 0.2 | 50 | <0.01 |
| Zn | <5 | 7.9 | 0.1 | 50 | <0.01 |
| Pb | <2 | 6.3 | 0.2 | 50 | <0.01 |
| Co | <5 | 41.3 | 0.2 | 50 | <0.01 |
| Ni | <2 | 16.6 | 0.5 | 50 | <0.01 |

The major ions of AMD are Ca, Mg, Na, Al, Fe and sulphate. It also contains traces of Co, Cu, Ni, Pb and Zn. After treatment, the resultant water contained reduced concentrations of Co, Cu, Ni, Pb and Zn. Modelling simulations showed that in the feed water, Co, Cu, Ni, Pb and Zn were in their divalent states. After treatment, modelling predicted that Co, Cu, Ni, Pb and Zn precipitated as metal hydroxides. The precipitated minerals have been presented in the Table 5. As shown in Table 6, it can be seen that cryptocrystalline magnesite managed to reclaim water to irrigation standards except for pH.

2.7 Comparison between Results of the Present Invention and Related Technologies

Comparisons of percentages of metal species removed from aqueous solution using different materials, as reported herein and in the open literature, are presented in Table 7.

TABLE 7
Metal species removal using different materials

| Species | Conc | | Feedstock | pH | (%) |
|---|---|---|---|---|---|
| Co(II), Cu(II), Ni(II), | 50 | mg/L | cryptocrystalline | 10 | >99 |
| Pb(II), Zn(II) | | | magnesite | | |
| Cu(II), Zn(II), Cr(III), | 100 | mg/L | CaO | 7-11 | >99 |
| Pb(II) | | | | | |
| Pb(II), Cu(II), Zn(II), | 1000 | mg/L | Phosphate rock | — | >99 |
| Co(II) | | | | | |
| Cu(II), Zn(II) | 150 | mg/L | Natural clay | 8 | >80 |
| Cr(II), Pb(II), Cd(II), | 10 | mg/L | Serbian natural clay | 5.5 | 81-98 |
| Ni(II) | | | | | |
| Fe(III), Zn(II), | 40-120 | mg/L | Natural zeolite | 4.5 | >80 |
| Mn(II), Cu(II) | | | | | |

It is evident that the removal efficiency of cryptocrystalline magnesite towards Co(II), Cu(II), Ni(II), Pb(II), Zn(II) is comparable to commercial and other known technologies.

### CONCLUSIONS

The following conclusions can be drawn:
Microstructural characterization revealed that the magnesite used is of cryptocrystalline nature.
Optimum conditions for removal of heavy metals from aqueous solution were observed to be about 30 minutes of shaking, 50 mg L⁻¹, 1: 100 S/L ratios, 250 rpm shaking speed and 25° C. room temperature.
Greater than 99% metal species removal efficiency was achieved
Final equilibrium pH of >10 was achieved.
PHREEQC geochemical modelling predicted that species exist as divalent ions at pH<4.
PHREEQC also predicted that metal species precipitates mainly as metal hydroxides at varying pH levels.
Cryptocrystalline magnesite can be applied successfully to reclaim acidic mine wastewater to DWAS standards for irrigation use.

1.-14. (canceled)

15. A process for the treatment of contaminated acidic water comprising metal or metalloid ions as contaminants, the process including contacting the contaminated water with particulate cryptocrystalline magnesite thereby to remove one or more contaminants from the water at a pH greater than 10.

16. The process claimed in claim 15, wherein the contaminated water comprises oxyanions of one or more elements selected from the group consisting of arsenic, chromium, boron, selenium and molybdenum and said oxyanions are removed from the contaminated water by contact with the cryptocrystalline magnesite.

17. The process claimed in claim 15, wherein contacting the contaminated water with cryptocrystalline magnesite includes using sufficient cryptocrystalline magnesite to raise the pH of the water to between 10 and 12, preferably to between 10 and 11.

18. The process claimed in claim 15, wherein the metal ions removed from the water as contaminants are selected from the group consisting of Al, Mn, Ca, Mg and Fe ions that precipitate as hydroxides, oxyhydrosulphates or hydrosulphates.

19. The process claimed in claim 15, wherein the metal ions removed from the water as contaminants are divalent ions selected from the group consisting of Co(II), Cu(II), Ni(II), Pb(II) and Zn(II).

20. The process claimed in claim 15, wherein the particulate cryptocrystalline magnesite has a particle size such that the particulate cryptocrystalline magnesite is able to pass through a 125 μm particle size sieve, preferably through a 75 μm particle size sieve, more preferably through a 50 μm particle size sieve, most preferably through a 40 μm particle size sieve.

21. The process claimed in claim 15, wherein the contaminated water is contacted with cryptocrystalline magnesite at a solid/liquid ratio of 0.5 kg-10 kg:10 L-150 L, preferably at a solid/liquid ratio of 0.5 kg-5 kg:10 L-150 L.

22. The process claimed in claim 15, wherein the contaminated water is contacted with cryptocrystalline magnesite for 10 to 80 minutes, preferably 50 to 70 minutes.

23. The process claimed in claim 15, wherein the contaminated water is acid mine drainage.

24. The process claimed in claim 15, wherein the contaminated water is industrial waste water containing metal or metalloid ions.

25. The process claimed in claim 24, wherein the industrial waste water comprises divalent metal ions, and wherein the contaminated water is contacted with cryptocrystalline magnesite for 20 to 40 minutes.

26. The process claimed in claim 25, wherein the divalent metal ions are selected from the group consisting of Co(II), Cu(II), Ni(II), Pb(II) and Zn(II).

27. The process claimed in claim 16, wherein the oxyanions are selected from the group consisting of sulphates, phosphates and nitrates.

28. The process claimed in claim 15, wherein the cryptocrystalline magnesite is obtained at least in part from magnesite tailings from a cryptocrystalline magnesite mining operation, or is obtained at least in part from a magnesite tailings dam.
